(19) United States
(12) Patent Application Publication
(10) Pub. No.: US 2001/0049302 A1
(43) Pub. Date: Dec. 6, 2001

(54) Game controller

(75) Inventors: Yasuji Hagiwara, Fukushima-ken (JP); Masahiro Soma, Fukushima-ken (JP); Youtaro Sakakura, Fukushima-ken (JP); Hiroshi Nakahama, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 09/819,391

(22) Filed: Mar. 28, 2001

(30) Foreign Application Priority Data
May 24, 2000 (JP) 2000-152570

(51) Int. Cl. A63F 13/00

(52) U.S. Cl. 463/37; 273/148 B

(57) ABSTRACT

A controller has an operation member, a speaker as sound emission unit, and a support member. The operation member is rotatably supported by the support member, and the speaker is provided in a rotation central portion of the operation member. In this arrangement, a sound source can be provided near an operator. Further, a sound outputted from the speaker is transmitted as a vibration source to a grip.

### BACKGROUND OF THE INVENTION

1. Field of the Invention

The present invention relates to a game controller which is used while it is placed on a floor or the like or manually held, and more particularly, to a game controller having sound emission means.

2. Description of the Related Art

FIG. 6 is a block diagram showing the construction of a conventional game machine installed in a house, an amusement arcade and the like.

In this type of game machine, when an operator operates a controller 6, an operation signal is generated by the controller 6. The operation signal is transmitted via a controller control unit 5 and a driver 4 to, e.g., a main body control unit 1 of the game machine main body. The main body control unit 1 reads a game program 2 and generates image data to be displayed on a display 3, further, inputs the operation signal from the controller 6 and reflects the operation in the image data displayed on the display 3. Further, the main body control unit 1 sends an audio output signal, based on the image displayed on the display 3 from the game program 2, to audio output means 7. In case of home game machine, a television screen is used as the display 3, and in case of amusement arcade game machine or the like, a specialized display 3 is used.

However, in the above conventional game machine, as the audio output means 7 is provided on the game machine main body side, a sound is emitted from a position away from the controller 6 manipulated by the operator, thereby the realism of the game is poor. Further, in case of game machine for home use, as the operator cannot enjoy such game while emitting a large sound at nighttime, thereby the realism is reduced.

### SUMMARY OF THE INVENTION

The present invention has been made to solve the above problems, and has its object to provide a game controller which attains sufficient realism, and even in a condition where a large sound cannot be emitted in a home game machine or the like, prevents degradation of realism.

According to the present invention, the foregoing object is attained by providing a game controller comprising: a support member that is placed or manually held while being used; operation means provided in the support member; wired or wireless transmission means for performing signal transmission with an apparatus main body; and sound emission means, wherein a sound emission signal is supplied to the sound emission means from the apparatus main body via the transmission means.

In the game controller, as a sound is emitted from a position where the operator performs an operation, the sense of realism can be satisfactorily obtained. Further, in case of home game machine, as a sound is emitted from a position around the operator's hand, game operation with sense of realism can be performed without increasing the volume of the sound itself.

For example, a sound emitted from the sound emission means based on the sound emission signal is a part of a sound emitted on the side of the apparatus main body or is different from the sound emitted on the side of the apparatus main body.

In this manner, as the sound emitted on the apparatus main body side is different from that emitted on the controller side, the sense of three-dimensional game operation and the sense of realism can be obtained.

Note that in the present invention, it may be arranged such that a sound is not caused on the apparatus main body side but emitted only from the sound emission means on the controller side, otherwise, it may be arranged such that the same sound is caused on the apparatus main body side and the controller side.

It may be arranged such that the sound emission means is provided in a part of the operation means. For example, the operation means is a steering handle rotatably provided on the support member, and wherein the sound emission means is provided in a rotation central portion of the steering handle.

Otherwise, it may be arranged such that the sound emission means is provided in the support member.

Further, it may be arranged such that the transmission means for transmission between the controller and the apparatus main body is wired transmission means using a cable or wireless transmission means using a radio wave or infrared radiation.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a front view of a game controller according to a first embodiment of the present invention;

FIG. 2 is a block diagram showing the system configuration of the game controller of the present invention;

FIG. 3 is a front view of the game controller according to a second embodiment of the present invention;

FIG. 4 is a front view of the game controller according to a third embodiment of the present invention;

FIG. 5 is a front view of the game controller according to a fourth embodiment of the present invention; and

FIG. 6 is a block diagram showing the system configuration of the conventional game controller.

### DETAILED DESCRIPTION OF THE PREFERRED EMBODIMENTS

Preferred embodiments of the present invention will now be described in detail in accordance with the accompanying drawings.

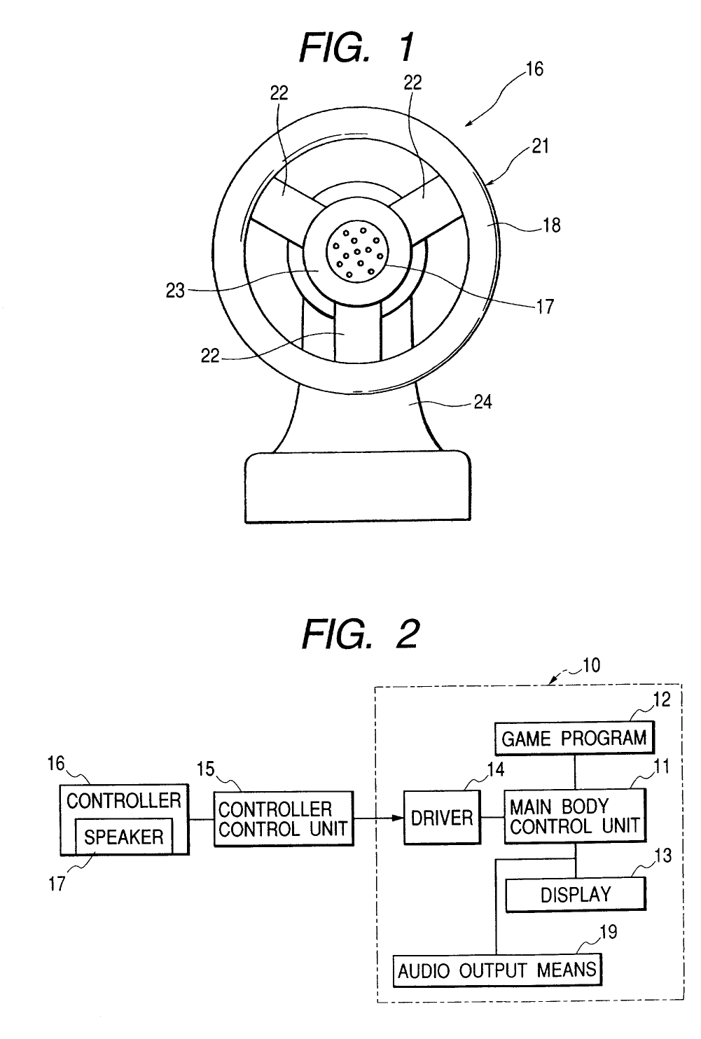

FIG. 1 is a front view of a game controller according to a first embodiment of the present invention. FIG. 2 is a block diagram showing the system configuration of the game controller of the present invention.

The game controller in FIG. 1 is, e.g., a steering wheel-type controller 16 used in a car race game and the like. The controller 16 has an operation member 21, a speaker 17 as sound emission means and a support member 24.

The controller 16 is connected to a game machine main body 10 via a predetermined cable. The game machine main body 10 has a display 13 and audio output means (speaker) 19. In case of home game machine, a television set is used as the display 13 and the audio output means 19.

In a large simulation game machine installed in an amusement spot and the like, a specialized display 13 and the audio output means 19 are integrated into the game machine main body 10. Otherwise, the display 13 and the audio output means 19 can be applied to a game machine utilizing a personal computer. Further, it may be arranged such that the controller 16 and the game machine main body 10 communicate with each other by wireless transmission means using a radiowave or infrared radiation.

The operation member 21 of the controller 16 has a grip 18 held by an operator upon manipulation, a rotary shaft 23 which rotatably supports the grip 18, and supports 22 which fix the grip to the rotary shaft 23. The speaker 17 is provided at the center of the rotary shaft 23. The rotary shaft 23 is rotatably supported by the support member 24. The support member 24 is installed in an arbitrary position for input operation.

As shown in FIG. 2, in the game controller of the present invention, the controller 16, where the speaker 17 is integrally provided, includes a controller control unit 15 therein. The controller control unit 15 performs processing to convert an analog signal generated by rotational operation of the controller 16 into a predetermined digital signal or the like. Further, the game machine main body 10 has a storage unit holding a game program 12 and a driver 14 which processes an operation signal from the controller 16 and supplies the processed signal to a main body control unit 11.

The main body control unit 11 converts data read from the game program 12 into image data and outputs the image data to the display 13. Further, in the main body controller 11, audio data read from the game program 12 is converted into predetermined audio data by the driver 14 and the controller control unit 15, and performs audio output from the speaker 17 on the controller 16 side.

When the controller 16 is operated, an operation signal is outputted. At this time, the operation signal is converted by the controller control unit 15 to predetermined data, then, via the driver 14, converted into image data in the main body control unit 11, and reflected in the image data displayed on the display 13.

In this manner, as the speaker 17 is provided on the controller 16 side, the operator can hear or sense the sound, and further, can directly receive vibration of the sound, thereby enjoys the game full of realism. Note that it may be arranged such that one speaker 17 is provided at the center of the rotary shaft 23 or plural speakers 17 are separately provided at the center of the rotary shaft 23.

Note that the same sound may be outputted from the speaker 17 of the controller 16 and the audio output means 19 of the game machine main body 10, however, a part of the sound emitted from the audio output means 19 may be outputted from the speaker 17. For example, in case of car race game, it may be arranged such that the entire sound is emitted from the audio output means 19 of the game machine main body 10 and the sound of engine of the car is outputted from the speaker 17 and the audio output means 19. Otherwise, different sounds may be emitted from the audio output means 19 and the speaker 17. For example, a cheer arose from the spectators, the sound of braking and the like may be emitted from the audio output means 19, and the sound of engine, the sound of shift change and the like may be emitted from the speaker 17. Further, it may be arranged such that sounds are emitted only from the speaker 17 on the controller 16 side.

Further, an adjustment member such as a volume-control knob for the speaker 17 may be provided on, e.g., the support member 24 of the controller 16. Further, means for switching sound emission between the speaker 17 and the audio output means 19 may be provided.

Further, in the controller 16, as the vibration of the sound outputted from the speaker 17 is transmitted to the grip 18, the sound can be a vibration source to provide vibration to the controller 16. Accordingly, in case of amusement arcade game machine, the volume of sound may be raised to increase occurrence of vibration, thereby producing a more real effect. In case of home game machine, even if the volume of sound is turned down, as vibration in correspondence with the volume is provided to an operator, the operator enjoy realism of the game.

When the game controller of the present invention is used as a single apparatus, it may be arranged such that a removable attachment member having a suction cup is provided on the bottom surface of the support member 24 and the support member 24 is placed on a floor or desk. Further, it may be arranged such that other controllers such as an accelerator pedal and a brake pedal are provided for attaining further improved realism.

Further, as the speaker 17, various types of speakers such as a corn-shaped speaker and a flat speaker may be used.

FIG. 3 is a front view of the game controller according to a second embodiment of the present invention.

Note that a controller 26 used as the game controller has a similar construction to that shown in FIG. 1. The operation member 21 has the grip 18, the rotary shaft 23 and the supports 22. In this embodiment, speakers 27 facing the operator side are provided in the supports 22. As the sound source is divided into three sources, the operator is positioned at approximately the center of the three sound sources. As the operator stereophonically receives the sounds, the sense of realism can be improved. In this case, it may be arranged such that speakers respectively for low-pitched sound, middle-pitched sound and high-pitched sound are provided as the speakers 27.

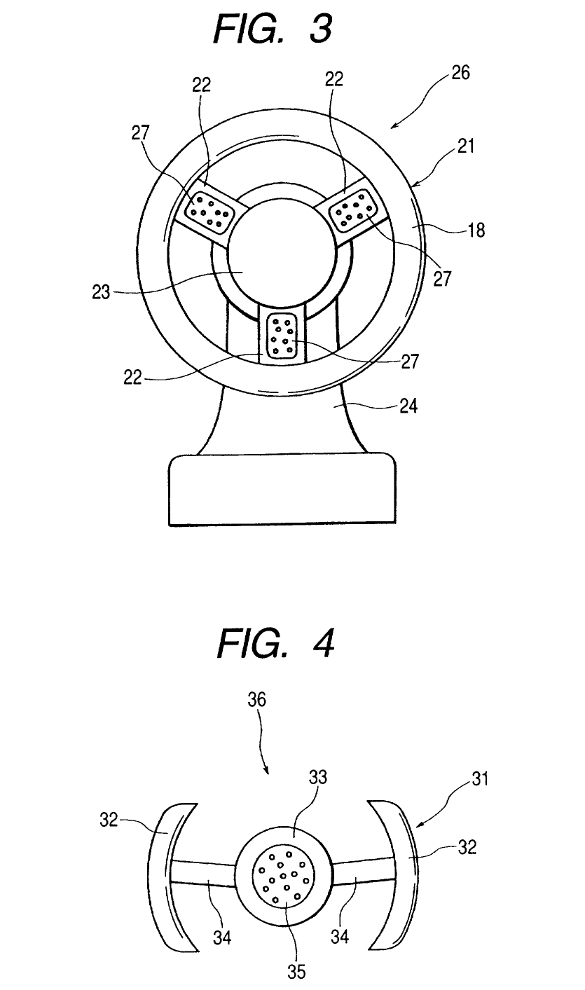

FIG. 4 is a front view of the game controller according to a third embodiment of the present invention.

The game controller in FIG. 4 having a shape of aircraft control lever can be used in fright simulation game and the like. A controller 36 used as the game controller has an operation member 31 and a speaker 35. The operation member 31 has grips 32, a rotary shaft 33 and supports 34 supporting the grips 32 and the rotary shaft 33. The speaker 35 is provided at the center of the rotary shaft 33.

Note that the speaker 35 may be provided in the supports 34. In this case, the plural speakers 35 enable stereophonic reproduction, thus realize stereophonic sound representation, which improves the sense of reality.

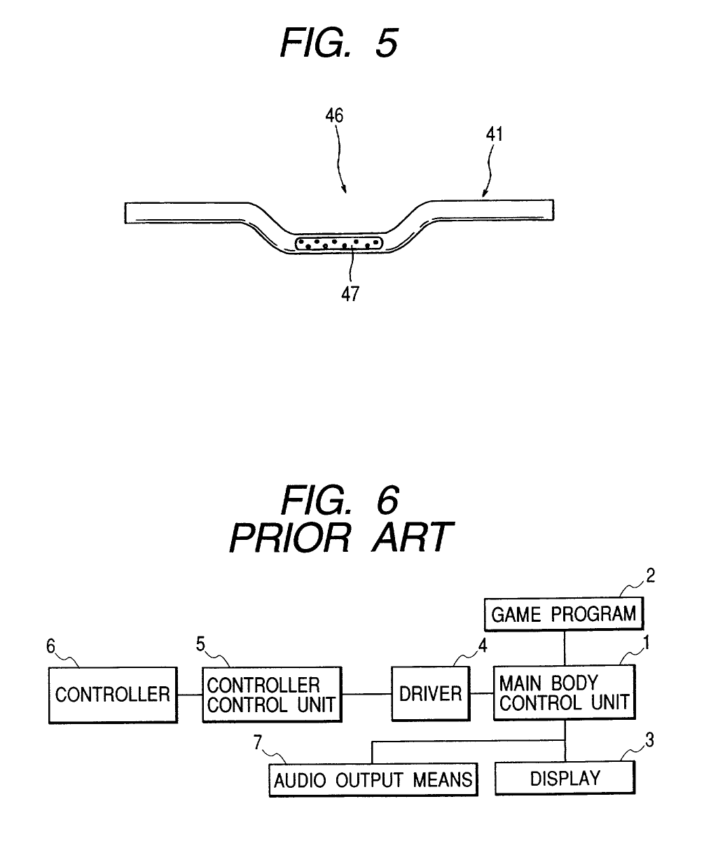

FIG. 5 is a front view of the game controller according to a fourth embodiment of the present invention. The game controller in FIG. 5, which used in bicycle operation simulation game and the like, has a grip 41 and a speaker 47 provided integrally with the grip 41. The controller is rotatably supported by a support member (not shown) at the center of the grip 41 in its widthwise direction.

Note that the embodiments shown in FIGS. 4 and 5 provide similar advantages to those provided by the game controller shown in FIG. 1, therefore, the explanations of the advantages will be omitted.

The game controller of the present invention can be applied to other games than the above described games as long as the games are simulation type games in which an operator inputs operation information.

As described above, according to the present invention, as the sound emission means is provided in the controller, the sound source can be provided near the operator. Thus the stereophonic sound effect can be produced. Further, as the vibration of output sound can be transmitted to the operator and the controller, the realism can be improved in comparison with conventional game controllers.

As many apparently widely different embodiments of the present invention can be made without departing from the spirit and scope thereof, it is to be understood that the invention is not limited to the specific embodiments thereof except as defined in the appended claims.

What is claimed is:

1. A game controller comprising:
a support member that is placed or manually held while being used;
operation means provided in the support member;
wired or wireless transmission means for performing signal transmission with an apparatus main body; and
sound emission means,
wherein a sound emission signal is supplied to the sound emission means from the apparatus main body via the transmission means.

2. The game controller according to claim 1, wherein a sound emitted from the sound emission means based on the sound emission signal is a part of a sound emitted on the side of the apparatus main body or is different from the sound emitted on the side of the apparatus main body.

3. The game controller according to claim 1, wherein the sound emission means is provided in a part of the operation means.

4. The game controller according to claim 3, wherein the operation means is a steering handle rotatably provided on the support member, and wherein the sound emission means is provided in a rotation central portion of the steering handle.

5. The game controller according to claim 1, wherein the sound emission means is provided in the support member.
